(19) United States
(12) Patent Application Publication
(10) Pub. No.: US 2018/0107723 A1
(43) Pub. Date: Apr. 19, 2018

(54) CONTENT ORIENTED ANALYSIS OF DUMPS

(71) Applicant: International Business Machines Corporation, Armonk, NY (US)

(72) Inventor: Jijiang Xu, Ottawa (CA)

(21) Appl. No.: 15/293,058

(22) Filed: Oct. 13, 2016

(51) Int. Cl. G06F 17/30; G06F 11/07

(52) U.S. Cl. CPC G06F 17/30569; G06F 11/0778; G06F 17/30905; G06F 17/30908

(57) ABSTRACT

A system and method for providing content oriented analysis information following a dump is disclosed. The method receives a memory dump and an engine determines a request location from the dump. A request object is located based on the request location. A representation of the request object is generated by converting the request object to a markup language format. The representation is then displayed to a user or administrator.

### BACKGROUND

The present disclosure relates to content oriented analysis, and more specifically, to providing content oriented data to a system administrator following a dump.

Currently there are a number of tools available to developers to investigate data structure thread stacks and data from a Java dump. These tools are helpful for product developers to conveniently diagnose problems with the underlying application. However, these tools are difficult for a system administrator or a support analyst to understand the problem or to find a solution to the problem without having a developer's assistance. Furthering this problem is that data structures are typically presented in a primitive manner that further makes the understanding of the data difficult.

### SUMMARY

One embodiment is directed to a method for providing content oriented analysis information to a user. The method receives a memory dump and an engine determines a request location from the dump. A request object is located based on the request location. A representation of the request object is generated by converting the request object to a markup language format. The representation is then displayed to a user or administrator.

One embodiment is directed to a system for providing content oriented analysis information to a user or administrator. The system includes at least one processor and a memory. The system receives a dump, containing a copy of the contents of the memory of a virtual machine at a particular time. The system further includes a library configured to store a definition for a request location in a standard markup language format. An extract module is configured to locate a request object from the definition for the request location and provide the request object back to the engine. The engine is configured to receive the dump, and request the definition from the library and provide the definition to the extract module, the engine further configured to receive from the extract module the request object, and the engine is further configured to convert the request object to the standard markup language format. Finally, the system includes a visualization component configured to display the converted request object.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating a system for enabling content oriented analysis of a memory dump according to one illustrative embodiment.

FIG. 2 is a flow diagram illustrating a process for processing a dump according to illustrative embodiments.

FIGS. 3 and 4 are illustrative screen captures produced by the visualization component of the current activities view and the request views according to some embodiments.

FIG. 5 is a block diagram illustrating a computing system according to one embodiment.

FIG. 6 is a diagrammatic representation of an illustrative cloud computing environment.

FIG. 7 illustrates a set of functional abstraction layers provided by cloud computing environment according to one illustrative embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to content oriented analysis for a system administrator following a dump. While the present disclosure is not necessarily limited to such applications, various aspects of the disclosure may be appreciated through a discussion of various examples using this context.

Currently there are a number of tools available to developers to investigate data structure thread stacks and metadata in a dump from a Java dump. These tools are helpful for product developers to conveniently diagnose problems with the underlying application. However, these tools are difficult for a system administrator or a support analyst to understand the problem or to find a solution to the problem without having a developer's assistance. Furthering this problem is that data structures are typically presented in a primitive manner that further makes the understanding of the data difficult.

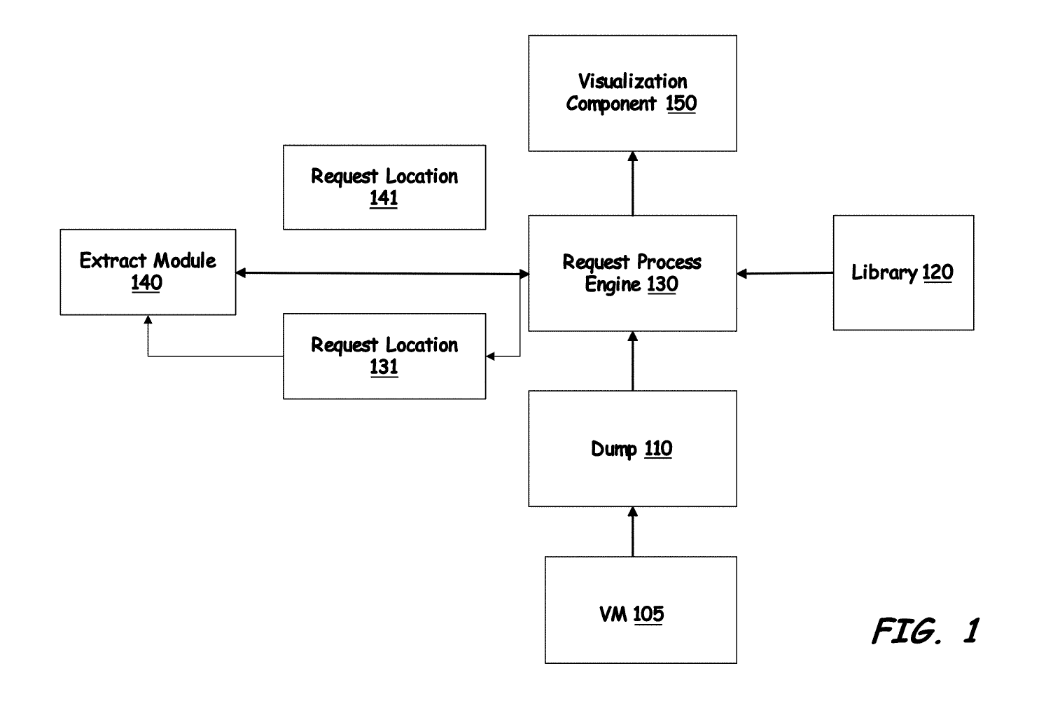

In order to assist the non-developer in diagnosing and finding solutions to the problems that arise from the analysis of a memory dump 110 from an application FIG. 1 illustrates a system for analyzing a memory dump 110. FIG. 1 is a block diagram illustrating a system 100 for enabling content oriented analysis of a memory dump 110 according to an illustrative embodiment. System 100 includes a library 120, an engine 130, an extract module 140, and a visualization component 150. The system 100 can operate on a single server, or may be distributed across multiple servers or platforms.

Dump 110 is a copy of the contents of the memory at a particular time. The dump 110 can be created by a request from a user or a session with an operation, parameters and options. The dump 110 can be, for example, a heap dump 110 or a system dump 110. A heap dump 110 is a snapshot of all the objects in a virtual machine 105 such as a Java Virtual Machine (JVM) heap at a certain point in time. The JVM software allocates memory for objects from the heap for all class instances and arrays. The garbage collector reclaims the heap memory when an object is no longer needed and there are no references to the object. When a virtual machine 105 such as a Java Virtual Machine (JVM) crashes the virtual machine can requests that the operating system to generate a system dump 110. A system dump 110 consists of all the memory that is being used by the virtual machine 105. This includes the application heap, along with all of the virtual machine and user libraries. System dumps 110 allow service personnel to look at the state of the virtual machine 105 at the time of crash, and help them with the problem determination process. Because a system dump 110 contains all of the memory allocated by the virtual machine process, system dump 110 files can be very large. The system dump 110 contains more information than the heap dump 110. However, both dumps 110 can include information that is valuable to an administrator in determining, for example, the cause of a memory exhaustion, resource starvation, a system or user exception, a crash, a dead lock, a slow performing system, etc.

The library 120 is a component of the system that stores or holds information that defines the request locations 131. The library 120 holds this information in a standard markup language format. For example, the format can be in the Extensible Markup Language or XML format. The data related to definition of the request location 131 can be for request locations 131 that are written or built for languages or formats used for the transmission of information such as, Json, HTTPRequest, ServletRequest, SOAPEnvelope, dom4j, J2EE request. However, other languages and formats can be used and present in the library 120. Further, the library 120 can be configured to store definitions that are custom or unique to the owning organization.

The engine 130 is a component of the system that is configured to receive the system dump 110 and generate a representation of a request in a standard markup language that permits the requests to be visualized by the visualization component 150. A request presents a user desire to have the system take certain actions. For example, for a SOAP request, it usually contains a header, and body. The header contains user session, communication context etc. The body contains the action, and options of the action. Another example of a request is a SQL query; it is a demand by a user to retrieve/add/modify certain data set in a relation database environment. The engine 130 reads the definition of the request location 131 from the library 120. The request location 131 can be for example an object type or an attribute name. However, any type of request may be the request location 131. The engine 130 is configured to provide this request location 131 to the extract module 140 in order to receive one or more request objects 141 based on the request location 131.

The engine 130 is further configured to convert the request objects 141 received from the extract module 140 and convert those request objects 141 to a format that can be displayed to the administrator. This includes converting the operations, the parameters and the options associated with the request object 141 to the desired format. In some embodiments the format is a standard markup language format. In one embodiment the engine 130 converts the request objects 141 to an XML format for visual consumption. However, the engine 130 can convert the request objects 141 to any format used by the visualization module. The process of converting the request object 141 to the format is not discussed in greater detail herein

The extract module 140 is a component of the system that is configured to locate the corresponding request object 141. The request objects 141 are the objects that were identified from the request location 131 such as object types and/or attribute names. The extract module 140 receives from the request location 131 information from the library 120 via the engine 130. However, in other embodiments the request location 131 information can come directly from the library 120. The extract module 140 uses the request location 131 information and traverses each thread in the dump 110 to locate the corresponding request object 141. In some embodiments the extract module 140 performs or executes a search to find the corresponding request object 141. This search can be a recursive search to retrieve an object embedded within other objects.

The visualization component 150 is a component of the system that is configured to display to the user and/or administrator the representation of the request objects 141. The visualization component 150 consumes the representation generated by the engine 130 to generate one or more views of the representation. In one embodiment the visualization component 150 generates a current activities view and a request view. The current activities view presents the request objects 141 in terms of the activity that was executing at the time of the dump 110. The current activities view can include presentation in terms of session, user, request id, memory usage, thread, and elapsed time. However, other activity categories can be present. The request view presents the request objects 141 in terms of the request details. In one embodiment the request details include a request header, a request body, request session information, etc. However, other views can be presented by the visualization component 150. Further organizations can design their own customized views to present the information in a format that is appropriate to that organization.

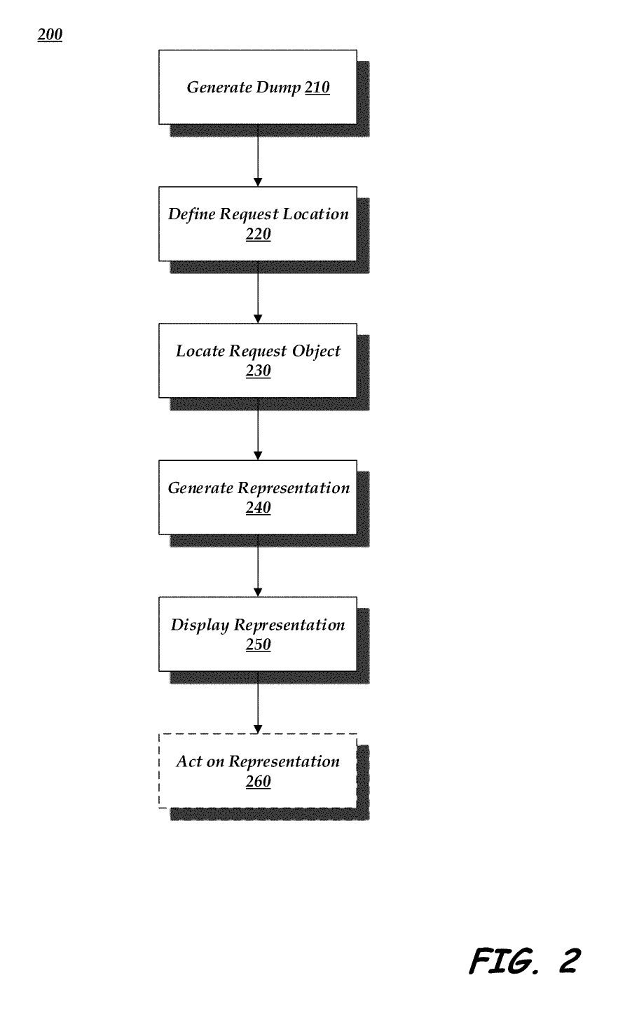

FIG. 2 is a flow diagram illustrating a process 200 for processing a dump 110 according to at least one illustrative embodiment. The process begins by generating a dump 110. This is illustrated at step 210. The dump 110 may be generated automatically by a virtual machine 105, such as a Java Virtual Machine following a memory exhaustion, resource starvation, a system or user exception, a crash, a dead lock, a slow performing system, etc. However, in other embodiments the dump 110 can be generated by the user or administrator requesting a dump 110. In this approach the administrator can call for the dump 110 to observe the current state of the virtual machine. Regardless of how the request to generate the dump 110 is initiated it can be initiated with an operation, parameters, and options.

Once the dump 110 has been generated it is passed to the engine 130 to determine the request location 131. This is illustrated at step 220. At this step the engine 130 read from the dump 110 the definition of the request location 131. As discussed above the request location 131 can be, for example, an object type, an attribute name, or other type of request. The request location 131 can be received or determined from the XML library 120 that defines these request locations 131.

The request location 131 is passed to the dump 110 information extract module 140 to locate the request objects 141. This is illustrated at step 230. The dump 110 information extract module 140 can walk through each thread in the dump 110 to locate the request objects 141. In some embodiments the dump 110 information performs a recursive search to find the request object 141. This can occur when the request object 141 is embedded in another object. Once the request objects 141 are found they are provided back to the engine 130.

The engine 130 receives the request object 141 and converts the request object 141 to a format that permits the visualization of the request object 141. This is illustrated at step 240. In one embodiment the format is an XML representation of the object. However, any other format can be used to generate a representation of the request object 141.

Following the conversion of the object to a representation that permits the viewing of the object the object is displayed to the administrator. This is illustrated at step 250. At this step the administrator can select from a number of possible views enabled by the representation. For example, in XML the administrator can view the request object 141 in an activities view and a request view. In some embodiments the administrator can leverage custom views beyond the activities view and the request view. This enables the administrator to view dumps 110 from custom products that are associated with that administrator's organization that are separate from other applications.

The administrator can utilize the views to act upon the information in the dump 110. This is illustrated at optional step 260. Through the view the administrator can determine who did the action that caused the dump 110, what they were doing at that time, and when they did the particular action. For example, in a memory exhaustion situation, the administrator through the views can determine that a session takes up to 4 GB of memory, identify the operation based on a corresponding SOAP requests. From the audit data in the dump 110 for the session find the individual involved in the memory exhaustion. With this information in hand the administrator can contact that individual to coordinate with that individual to stop the corresponding activity and stabilize the application without making any changes to the underlying product.

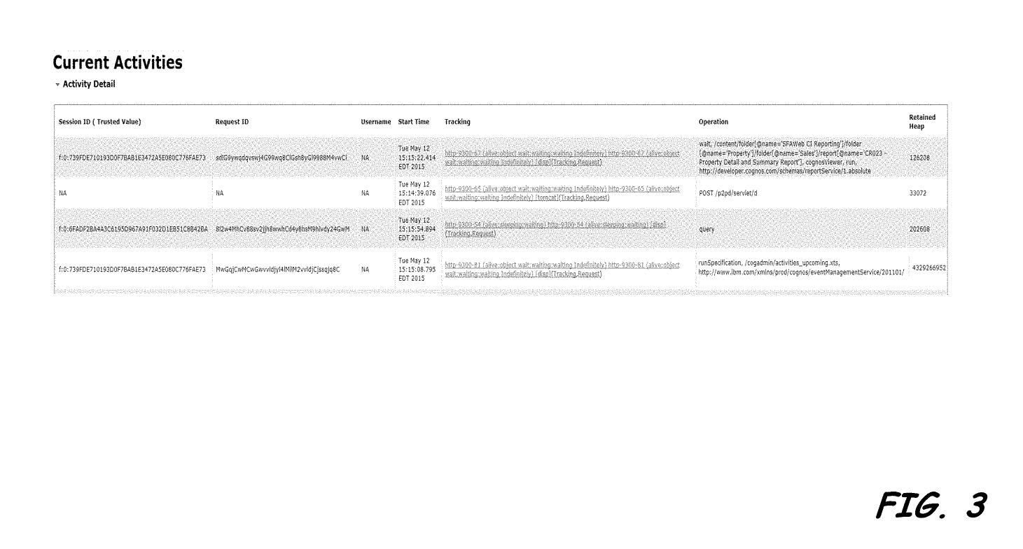

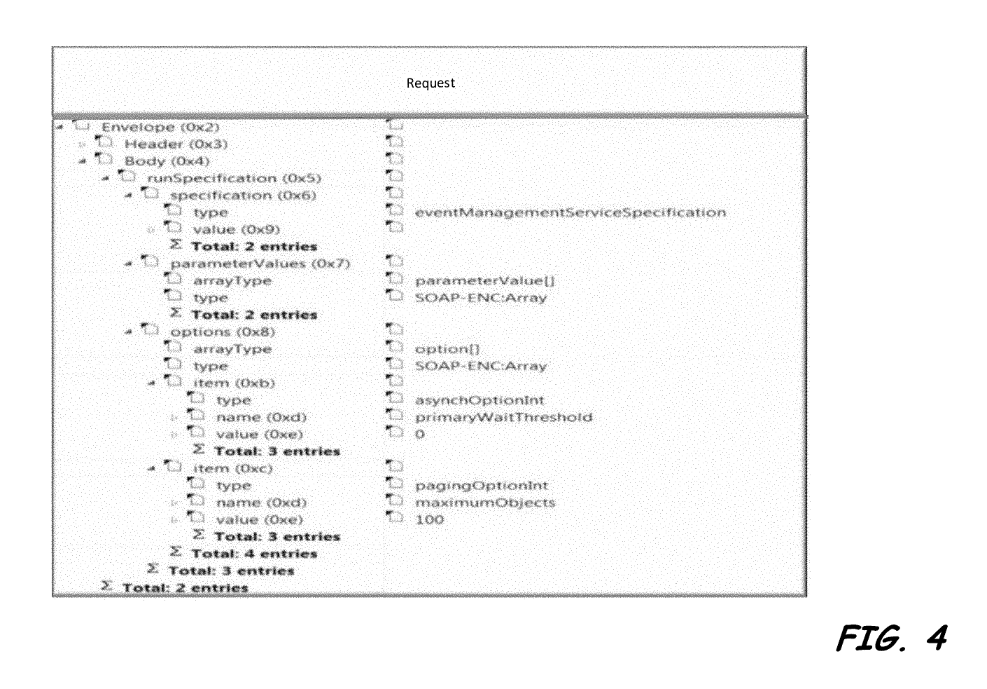

FIGS. 3 and 4 illustrate example screen captures produced by the visualization component 150 of the current activities view and the request views according to some embodiments. The visualization component 150 can display information to the administrator in a way that allows the administrator to interact with the information in an efficient manner. For example, the current activities view (FIG. 3) can provide information illustrating what thread and what user was causing a memory exhaustion. From the illustration the administrator can access a link to the thread to request the thread. This can then take the administrator to the request view (FIG. 4). In the request view the administrator can see the detail request header, including session and request information. The administrator can then drill down in to further detail such as getting the output of the thread, the specification, run parameters, and run options. While FIGS. 3 and 4 illustrate one example of a visualization, those skilled in the art will understand that other visualizations can be used to present the information in a way that allows the administrator understand the dump 110 without the assistance of a developer.

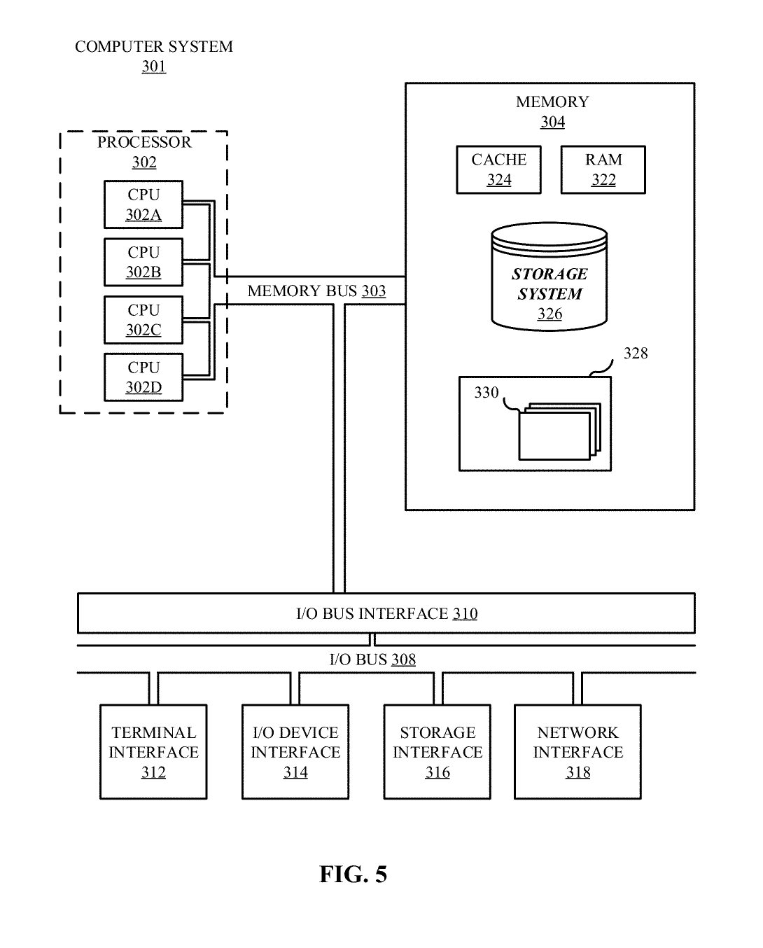

Referring now to FIG. 5, shown is a high-level block diagram of an example computer system 301 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 301 may comprise one or more CPUs 302, a memory subsystem 304, a terminal interface 312, a storage interface 316, an I/O (Input/Output) device interface 314, and a network interface 318, all of which may be communicatively coupled, directly or indirectly, for inter-component communication via a memory bus 303, an I/O bus 308, and an I/O bus interface unit 310.

The computer system 301 may contain one or more general-purpose programmable central processing units (CPUs) 302A, 302B, 302C, and 302D, herein generically referred to as the CPU 302. In some embodiments, the computer system 301 may contain multiple processors typical of a relatively large system; however, in other embodiments the computer system 301 may alternatively be a single CPU system. Each CPU 302 may execute instructions stored in the memory subsystem 304 and may include one or more levels of on-board cache.

System memory 304 may include computer system readable media in the form of volatile memory, such as random access memory (RAM) 322 or cache memory 324. Computer system 301 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 5 as a single bus structure providing a direct communication path among the CPUs 302, the memory subsystem 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 301 may, in some embodiments, contain multiple I/O bus interface units 310, multiple I/O buses 308, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 301 may be a multi-user mainframe computer system, a single-user system, or a server computer or similar device that has little or no direct user interface, but receives requests from other computer systems (clients). Further, in some embodiments, the computer system 301 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 301. In some embodiments, however, individual components may have greater or lesser complexity than as represented in FIG. 5, components other than or in addition to those shown in FIG. 5 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

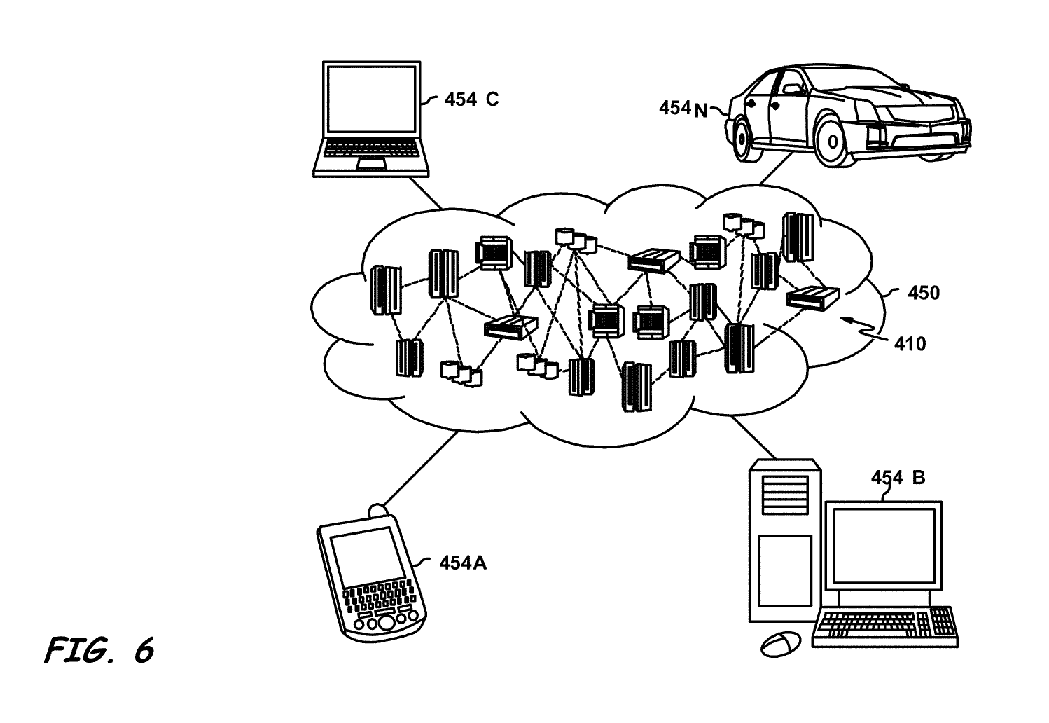

The system 100 may be employed in a cloud computing environment. FIG. 6, is a diagrammatic representation of an illustrative cloud computing environment 450 according to one embodiment. As shown, cloud computing environment 450 comprises one or more cloud computing nodes 410 with which local computing devices used by cloud consumers, such as, for example, personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 6 are intended to be illustrative only and that computing nodes 10 and cloud computing environment 450 may communicate with any type of computerized device over any type of network and/or network addressable connection (e.g., using a web browser).

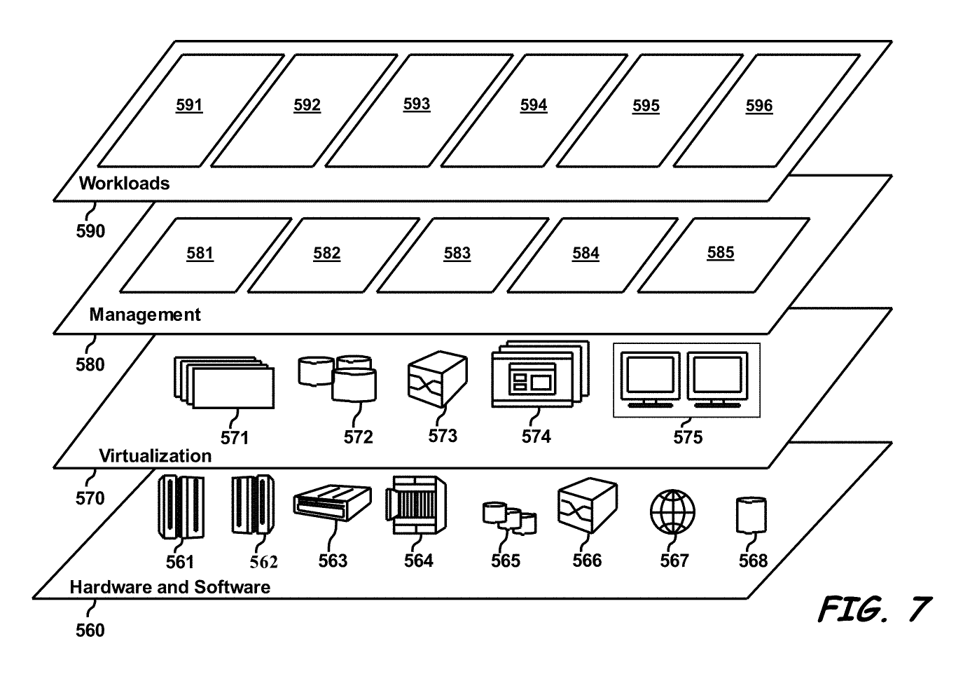

Referring now to FIG. 7, a set of functional abstraction layers provided by cloud computing environment 450 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and database 596.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
receiving a dump;
determining a request location from the dump;
locating a request object based on the request location;
generating a representation of the request object by converting the request object into a standard markup language format; and
displaying the representation.

2. The method of claim 1 wherein the dump is a memory dump.

3. The method of claim 1 wherein determining the request location determines the request location by reading a definition for the request location from a library.

4. The method of claim 3 wherein the definition is in a standard markup language.

5. The method of claim 1 wherein locating the request object further comprises:
traversing a thread in the dump to locate the request object.

6. The method of claim 5 wherein traversing further comprises:
searching, recursively, to locate the request object wherein the request object is embedded in another object.

7. The method of claim 1 wherein generating the request representation includes an associated operation, parameters and options.

8. The method of claim 1 wherein displaying the representation displays a current activities view.

9. The method of claim 8 wherein the current activities view comprises views for each item in the dump of an associated session, a request id, a memory usage, a thread and an elapsed time.

10. The method of claim 1 wherein displaying the representation displays a request view, the request view including for each item in the dump a request header and a request body.

11. The method of claim 1, prior to receiving the dump, further comprising:
generating the dump.

12. The method of claim 1 further comprising:
interacting, programmatically, with the displayed representation.

13. The method of claim 1 wherein the request location comprises an object type.

14. The method of claim 1 wherein the request location comprises an attribute name.

15. A system comprising:
at least one processor;
a memory;
a dump, the dump containing a copy of contents of the memory at a particular time;
a library configured to store a definition for a request location in a standard markup language format;
an extract module configured to locate a request object from the definition for the request location
an engine configured to receive the dump and request the definition from the library and provide the definition to the extract module, the engine further configured to receive from the extract module the request object, and the engine further configured to convert the request object to the standard markup language format; and
a visualization component configured to display the converted request object.

16. The system of claim 15 wherein the library stores a plurality of definitions for a plurality of request locations.

17. The system of claim 15 wherein the visualization component is further configured to display a current activities view and a request view, the current activities view representing the request as an associated session, a request id, a memory usage, a thread and an elapsed time, and the request view representing the request as a request header and request body.

18. The system of claim 15 wherein the extract module is further configured to traverse each thread of the dump to locate the request object, and is further configured to recursively search objects when the request object is embedded in another object.

19. A computer program product having computer executable instructions for providing content oriented analysis information that when executed cause at least one computer to:
receive a dump;
determine a request location from the dump by reading a definition for the request location from a library, wherein the definition is in a standard markup language;
locate a request object based on the request location;
generate a representation of the request object by converting the request object into a standard markup language format; and
display the representation.

20. The computer program product of claim 19 wherein the instructions to locate the request object further comprises instructions to:
traverse a thread in the dump to locate the request object.
search, recursively, to locate the request object when the request object is embedded in another object.
